(19) United States
(12) Patent Application Publication
(10) Pub. No.: US 2025/0296786 A1
(43) Pub. Date: Sep. 25, 2025

(54) GRIPPER FOR HOLDING AND DEPOSITING A SHEET-MATERIAL STACK, AND METHOD FOR HOLDING AND DEPOSITING A SHEET-MATERIAL STACK BY MEANS OF A GRIPPER

(71) Applicant: GIESECKE+DEVRIENT CURRENCY TECHNOLOGY GMBH, Munchen (DE)

(72) Inventors: Wolfgang KONIGER, Karlsfeld (DE); Andreas JAKOBS, Munchen (DE); Michael KNICKREHM, Augsburg (DE)

(21) Appl. No.: 18/860,451

(22) PCT Filed: Apr. 26, 2023
(86) PCT No.: PCT/DE2023/100302

§ 371 Date: Oct. 25, 2024

(30) Foreign Application Priority Data
May 3, 2022 (DE) 10 2022 001 542.0

(51) Int. Cl. B65G 47/90; B65H 5/00; B65H 7/00

(52) U.S. Cl. CPC B65G 47/90; B65H 5/006; B65H 7/00; B65H 2301/44338; B65H 2405/57

(57) ABSTRACT

A gripper is for holding and depositing a stack of sheet material at a depositing location, and has at least one first gripping element, which comprises or forms a first contact surface for contact with the stack, and at least one second gripping element, which includes a second contact surface for contact with the stack. The first and second contact surfaces are designed for contact with the stack on both sides. The gripping elements are guided adjustably with respect to one another so that the contact surfaces can be moved with respect to one another in the direction of the surface normals that are respectively associated with the contact surfaces to hold the stack between the contact surfaces. The first gripping element is mounted to pivot about a pivot axis so it can pivot between a gripping position, and a release position.

The present invention relates to a gripper for holding and depositing a stack of sheet material, in particular of value documents, at a depositing location, in particular on a base or on an existing stack of sheet material.

The invention relates moreover to an apparatus for moving and depositing a stack of sheet material and a method for depositing a stack of sheet material, in particular of value documents, at a depositing location, in particular on a base or on an existing stack of sheet material.

When processing stacked sheet material, it is known to deposit one or more stacks of sheet material with the aid of a gripper on a base or on an already existing stack of sheet material which is stacked on a base, where appropriate in a container. The gripper typically comprises two gripping elements which are movable with respect to one another and comprise gripping fingers between which the stack to be deposited is clamped. The sheets that form the sheet material are flat, usually flexible sheets. The sheets can each be formed from one layer or from multiple mutually connected layers or individual sheets.

For example, when preparing value documents, such as banknotes, tickets, admission tickets, vouchers, checks, amongst other things, for daily requirements, it is usual to store them as a stack for dispensing in self-service devices, by way of example in cash machines, (automatic teller machines, ATM), ticket dispensers, travel ticket dispensers, amongst other things. It has proven to be expedient to store the value documents as a stack in particular in a shaft-shaped receptacle in such a manner that the stacking direction runs at least along the vertical direction. Self-service devices for bank notes comprise, by way of example, value document cassettes having such shaft-shaped receptacles which can be loaded laterally and are configured with respect to the gravitational field in the vertical direction or inclined thereto. A value document container (also value document cassette) that is to be loaded with value document stacks can in particular, as is known by way of example from WO 2018/210447 A1, be vertical or inclined to the rear. Grippers are also used for the automated loading of such shaft-shaped receptacles.

The stack of sheet material to be deposited is deposited with the aid of the gripper in such a manner that the bottom sheet of the stack lies with its surface on the base or on the already existing stack of sheet material. Subsequently, the gripper is opened slightly and pulled out in the lateral direction from the deposited stack, i.e. substantially parallel to the surface of the bottom sheet of the stack. When the gripping fingers adjacent to the stack are pulled back or out, there is a problem that the lower gripping element, on which the stack to be deposited rests, can cause sheets to move in the lateral direction due to frictional forces and thus pull them out of the stack owing to frictional forces, in particular the bottom sheet of the stack to be deposited and/or the top sheet of an existing stack on which the particular sheet is deposited. The stack is then not deposited flush or precisely in position.

These frictional forces can be especially high particularly in the case of used banknotes since these tend to balloon and therefore exert an increased frictional force on the gripping fingers that are to be pulled out of the stack. Also in the case of value document cassettes used in self-service devices which comprise a base that is sprung in the stacking direction, it is possible for the frictional force between the value documents and the gripping fingers to be increased. As a result, it is possible, amongst other things, that the value documents that have been deposited as a stack by a machine do not lie precisely flush with one another, which particularly in the case of self-service devices can lead to dispensing errors, amongst other things. In practice, it is therefore usual that in particular self-service devices for dispensing banknotes continue to be loaded manually, which is intensive with regard to time and effort.

It is the object of the present invention to propose means by which sheet material, in particular value documents, can be deposited in a precise position.

The present invention achieves this object by the attached independent claims. Preferred embodiments of the invention are disclosed in the claims that are dependent thereon.

In accordance with one aspect of the present invention, a gripper is provided for holding and depositing a stack of sheet material, in particular a stack of value documents, at a depositing location, in particular on a base or on an existing stack of sheet material, in particular a stack of value documents. The gripper comprises at least one first gripping element, which comprises or forms a first contact surface for contact with the stack, and at least one second gripping element, which comprises or forms a further, second contact surface for contact with the stack. The first contact surface and the second contact surface are designed for contact with the stack on both sides in such a manner that the stack can be clamped between the first and the second contact surface. The first and the second gripping element are guided adjustably with respect to one another, wherein the first and the second contact surface can be moved towards one another, in particular in the direction of the surface normals that are respectively associated with the first and second contact surface, in order to hold the stack in particular in a non-positive locking manner between the first and the second contact surface. In accordance with the invention, the first gripping element is mounted so as to be able to pivot about a pivot axis. The first gripping element can pivot between a gripping position, in which the first contact surface is oriented substantially parallel to the second contact surface, and a release position, in which the first contact surface is oriented at an angle with respect to the second contact surface, in particular can pivot downwards or pivot away from the first gripping element.

The gripper is designed in an advantageous manner so as by means of simple mechanical means to stack sheet material in general and in particular to stack value documents, such as by way of example banknotes, tickets, admission tickets, vouchers, checks or the like in a precise position and in particular flush on top of one another. Precisely positioning stacks with the aid of automated apparatuses is a challenge that the invention proposes to solve by replicating the function of the human thumb.

For this purpose, the first gripping element is designed so as to be able to pivot so that it can be pivoted out of the gripping position away from the second gripping element in order to release or deposit at the desired depositing location the stack that is held between the first and the second contact surface.

In particular, the first gripping element can pivot out of the gripping position into the release position in such a manner that the stack gripped by the gripper can slide into the release position with the aid of the gravitational force along the first contact surface of the first gripping element and is thereby deposited at the depositing location. In this manner, when the gripper is suitably positioned at a depositing position above the desired depositing location, the stack can be deposited precisely on it.

In order to move the first and second gripping element towards one another and for the pivot movement of the first gripping element from the gripping position into the release position, the gripper can comprise one or multiple control elements, for example electric motors. In particular, the first and the second gripping element can be moved towards one another by means of at least one control element (for example electric motor) in order to grip the stack and where appropriate in order to compress the stack so that the gripping force (and thereby the reliability of the gripping) is increased. It is preferred that the first and the second gripping element can also be moved away from one another by means of at least the control element of the gripper in order to increase the distance between them prior to gripping the stack. The gripper is thereby configured so as to grip stacks of different sizes.

The gripper is configured so as to receive and hold the stack in such a manner that the two sheets, in particular value documents, which delimit the stack at each end in the stacking direction are in frictional contact by their surface respectively with the first contact surface or the second contact surface. The first or second contact surface is typically provided on each first or second gripping element by a flat contact or multiple smaller, in particular linear or punctiform, contacts for the stack that is to be held. It goes without saying that the first and second contact surface is to refer to the structural entirety of the intended points of contact and support on the stack that is to be held. By way of example, it is possible in the exemplary embodiments for at least one of the gripping elements to comprise, by way of example, multiple elongated gripping fingers which in their structural entirety define a first or second contact surface in the context of this description. The first and second contact surfaces are configured substantially parallel to one another in the gripping position, i.e. the contact surfaces that, where appropriate, are provided merely by punctiform or linear structures are designed and oriented in the gripping position in such a manner that the stack is held between two virtual planes that are at least in sections planar parallel. Deviations from this which are caused by the stack bending under its own weight are insignificant in this respect and are included by this definition.

The expression that the first and second contact surfaces are moveable with respect to one another in the direction of the surface normals that are associated with the first and second contact surfaces is to be understood to mean that the first contact surface and the second contact surface in the gripping position can move towards one another and/or away from one another while maintaining the substantially parallel orientation.

It is preferred that the first gripping element and the second gripping element are guided linearly adjustably with respect to one another. This renders it possible to avoid shearing movements when gripping the stack. It is possible in this manner to ensure that the first contact surface and the second contact surface can be moved towards one another in the gripping position whilst reliably maintaining their parallel orientation in order in particular to be able to grip the stack in a non-destructive manner.

It is preferred that the first contact surface is oriented in the release position at an angle of at least 45°, in particular substantially perpendicular, to the second contact surface. In other words, the first gripping element can pivot over an angle of at least 45°, for example 90°, about the pivot axis. The first contact surface can be rotated from the gripping position, in which the first contact surface is oriented substantially parallel to the second contact surface, into the release position, in which the first contact surface is oriented at an angle of at least 45°, in particular substantially perpendicular, to the second contact surface. In the perpendicular case, the first contact surface in the release position in the case of the intended use of the gripper runs parallel to the stacking direction of the deposited stack and can thus be used in further stack building to influence the periphery of the deposited stack in order to ensure in particular that the sheets, for example value documents, of the stack lie flush against one another.

In advantageous embodiments, the second gripping element is attached in a non-rotatable manner to the gripper. By way of example, the first gripping element and the second gripping element are guided linearly adjustably towards one another with respect to a carrier, wherein the first gripping element is arranged so as to be able to pivot about the pivot axis with respect to the carrier and the second gripping element is arranged in a non-rotatable manner with respect to the carrier.

The first gripping element and the second gripping element are preferably designed in such a manner that they support the center of gravity of the stack that is held by the gripper at least when the stacking direction of the stack in the holder with respect to the gravitational field is oriented in space at least approximately along the vertical direction.

Within the scope of this description, the vertical direction is defined in the conventional manner with respect to the gravitational field.

In advantageous embodiments, the first contact surface is formed by at least one elongated first gripping finger of the first gripping element and the second contact surface is formed by at least one elongated second gripping finger of the second gripping element, wherein a longitudinal extent of the at least one first gripping finger is shorter than a longitudinal extent of the at least one second gripping finger. The longitudinal extent of the first gripping finger is preferably at the most 80% of the longitudinal extent of the second gripping finger. The pivotably mounted, first gripping element is preferably shorter in order to reduce the area required by the pivot movement and to render it possible to deposit the stack in a precise position at the depositing location from a relatively small height.

In some configurations, the gripper can comprise a multiplicity of elongated, first gripping fingers which determine the first contact surface and are thus accordingly mounted so as to be able to pivot about the pivot axis. In some configurations, the second contact surface can likewise be determined by a multiplicity of second gripping fingers which run, by way of example, parallel to the first gripping fingers.

It is preferred that the first gripping element can move/moves away from the second gripping element by pivoting about the pivot axis in the direction of the release position in such a manner that the distance between the first contact surface and the second contact surface is continuously increased when pivoting from the gripping position into the release position. It is possible in this manner to avoid undesired shearing forces which act on the stack and which can be caused in particular by the first gripping element pivoting as the stack is deposited.

In order to avoid value documents of the existing stack being displaced by the pivot movement of the first gripping element, the depositing position of the gripper is selected such that in the depositing position the vertical distance of the pivot axis from the depositing location is greater than the longitudinal extent of the first contact surface of the first gripping element.

In accordance with a second aspect of the invention, an apparatus is provided for moving and depositing a stack of sheet material, which comprises the above described gripper and a control facility for controlling the movement of the first and second contact surface or of the first and second gripping elements with respect to one another, in particular with respect to the distance and/or the orientation. The control facility is designed so as to control the pivot movement of the first gripping element from the gripping position into the release position by actuating relevant control elements, such as electric motors or the like.

It is preferred that the apparatus comprises a transport facility which is designed so as to move the gripper to different positions in space and to set it up in different orientations in space, in particular with respect to the gravitational field. In this case, the control facility is designed so as to control the movement and orientation of the gripper in space by actuating relevant control elements, such as electric motors or the like. For this purpose, in the simplest case, it is necessary to control at least one additional degree of freedom of movement of the transport facility.

In particular, the control facility is designed so as to actuate the at least one control element of the gripper so that the first and the second gripping element are moved away from one another prior to gripping the stack in order to increase their distance from one another and/or to actuate the at least one control element of the gripper so that the first and the second gripping element are moved towards one another in order to grip the stack and, where appropriate, also to actuate them so that as the stack is gripped, it is compressed between the first and the second gripping element, for example by a specific distance or until a specific counter force of the stack is achieved.

In advantageous embodiments, the transport facility comprises multiple axes which are linearly and/or rotatably adjustable with respect to one another. In this manner, it is possible, by way of example, to implement complex movements of the gripper with a plurality of degrees of freedom of movement. By way of example, the gripper is arranged at the end of an articulated multi-arm robot or rotatably and/or movably mounted in any other way in a suitable manner.

In one embodiment, the apparatus is designed so as to receive a stack, which is formed as a stack of value documents, from a value document container, by way of example from an upwardly open transport container for banknotes, by means of the gripper, to transport the stack to a value document cassette, by way of example a cash machine, and to place the stack into the value document cassette. It is preferred that the apparatus is designed so as to load value document cassettes or value document containers which can be loaded from the side, wherein the cassette or container is loaded in a lateral direction, i.e. with a movement component perpendicular to the gravitational field and in fact preferably in the manner that the stacking direction of the stack is oriented at least approximately along the vertical direction. In particular, it is common for value document cassettes to be stored vertically or slightly tilted inclined to the rear in the case of self-service devices for dispensing cash which comprise appropriately configured shafts which are to be loaded with value document stacks, in particular with stacks of banknotes.

For the purposes of this description, a container for value documents which is designed so as to store the value documents in stacks in a shaft-shaped receptacle that is oriented at least approximately along the vertical direction is in particular regarded as a value document cassette in the strict sense. The expression that the shaft-shaped receptacle or the stacking direction of the stack is oriented at least approximately along the vertical direction is to be understood in particular to mean that the stacking direction deviates from the vertical direction by less than 30°. It is advantageous that the stacking direction is to be arranged in a slightly tilted manner with respect to the gravitational field, since this facilitates the sliding of the stack as it is deposited on the first contact surface under the influence of the gravitational force.

It can be provided that the base in the value document cassette is sprung in the stacking direction of the value documents that are to be placed therein. The pivot movement of the first gripping element then renders it possible to avoid a physical contact of the first gripping element when depositing with elements at the dispensing location, for example with value documents already stacked there, so that increased friction caused by springiness in the stacking direction is insignificant in this respect.

It is preferred that the movement and orientation of the gripper in space can be controlled with the aid of the control facility independently of the movement and orientation of the first and second contact surfaces with respect to one another. In other words, the movement sequences for opening and closing the gripper on the one hand and the movement sequences for moving or orienting the gripper in space on the other hand can be controlled independently of one another in the sense that it is possible to open and close the gripper irrespective of its position and orientation in space.

The control facility can be designed in particular so as to position the gripper holding the stack into a depositing position in which the first contact surface is arranged below the second contact surface and to deposit the stack that is held by the gripper by means of the gripper that is located in the depositing position, wherein, in order to deposit the stack, the first contact surface is pivoted from the gripping position into the release position in which the first contact surface is oriented at an angle, preferably at an angle of at least 45°, with respect to the second contact surface.

Moreover, the control facility can be designed so as to select the depositing position of the gripper in such a manner:
that in the depositing position the center of gravity of the stack that is held by the gripper is arranged in the vertical direction above the depositing location of the stack, and/or
that in the depositing position the vertical distance of the pivot axis from the depositing location is greater than the longitudinal extent of the first contact surface of the first gripping element.

The control facility can also be designed so as to control the gripper in such a manner that, after the stack that is held by the gripper has been deposited, the first contact surface is moved in a direction perpendicular to a stacking direction of the stack in order to influence the periphery of the stack and thus to orient it in a flush manner.

In accordance with a third aspect of the invention, a method is proposed for depositing a stack of sheet material, in particular of value documents, at a depositing location, in particular on a base or on an existing stack of sheet material, in particular a stack of value documents. The method comprises the steps:
hold a stack of sheet material, in particular of value documents, between a first and a second contact surface of a gripper, in particular of the above already described gripper, in a gripping position, wherein the first and the second contact surfaces are arranged parallel to one another in the gripping position;
position the gripper in a depositing position in which the center of gravity of the stack that is held by the gripper is arranged in the vertical direction above the depositing location at which the stack that is held by the gripper is to be deposited, wherein the gripper is oriented in the depositing position in such a manner that the first contact surface is arranged in the vertical direction below the second contact surface;
deposit the stack that is held by the gripper, wherein, in order to deposit the stack, the first contact surface is pivoted from the gripping position into a release position in which the first contact surface is oriented at an angle with respect to the second contact surface and thus tilted.

Due to the arrangement and orientation of the gripper in the depositing position above the depositing location and by virtue of the fact that the gripper is opened by the first contact surface being tilted into the release position, it is rendered possible for the stack with the aid of the gravitational force to slide along the first contact surface to the depositing location which is predetermined, by way of example, by the base or by an already existing stack. The lower, first gripping element which supports the stack is thus pivoted out of the stack before the stack impinges against the base lying under it or against the already existing stack. In this manner, mechanical means render it possible to deposit the stack of sheet material, in particular of value documents, in a precise position.

In particular, the depositing location of the stack can be located in a value document cassette or in an input tray of a value document processing apparatus (which is to process the stack), in which the base or the already existing stack can be located. In both cases, as the stack is deposited, it is placed with its rear side remote from the gripper (with the edges of the value document facing away from the gripper), against a rear wall of the value document cassette or of the input tray, (the rear wall being immovable with respect to the gripper). The rear wall, which can be contacted by the rear side or rear edges of the stack when the stack is deposited, or is at a very close distance from them when the stack is deposited, ensures the correct orientation of the edges in the deposited stack. In order to be able to deposit the stack as close as possible to the rear wall of the value document cassette or the input tray, the gripper grips/holds the stack only via the front side of the stack which is opposite the rear side of the stack. While the gripper is gripping/holding the stack, the rear side of the stack gripped/held at the front side is not gripped or held either by the gripper or any other facility. The rear side of the stack remains free so that the gripper can insert it into the value document cassette or into the input tray.

In preferred embodiments of the method, the first contact surface is oriented in the release position at an angle of at least 45°, in particular perpendicular, to the second contact surface. In the perpendicular case, the first contact surface consequently runs substantially along its stacking direction after the stack has been deposited in the intended manner.

In particular, the depositing position is selected in such a manner that in the depositing position the center of gravity of the stack that is held by the gripper is in the vertical direction (directly) above the depositing location of the stack, i.e. over the base or over the existing stack. As a consequence, the stack is simply and reliably deposited at the depositing location by means of the gravitational force.

After the stack has been deposited, it is preferably provided to influence the periphery of the deposited stack with the first contact surface that is oriented in the release position in order to correct any stack defects which can include sheets, for example value documents, which do not lie exactly flush on top of one another. In order to influence the periphery of the deposited stack, it is provided that the first contact surface moves laterally in one direction perpendicular to the stacking direction.

Moreover, in advantageous embodiments of the method, prior to the step of positioning the gripper into the depositing position, the gripper moves in the space from a receiving position, in which the stack is gripped by the gripper, to the depositing position, in particular with the aid of the above already described transport facility,

A value document stack can be removed from a value document container, by way of example with the aid of the gripper at the receiving position and with the aid of the gripper transported to the depositing position above the depositing location in order, by way of example, to place the stack in a precise position in the loading shaft of the value document cassette, the loading shaft being oriented in the vertical direction.

Further features and advantages of the method also arise from the description above and below with regard to the gripper and the apparatus which is configured in particular so as to control the movement and depositing of the gripper according to the specification of the proposed method.

Further aspects, features and advantages of the present invention become clear with reference to the detailed description below of preferred embodiments and embodiment variants of the present invention with regard to the attached figures, in which:

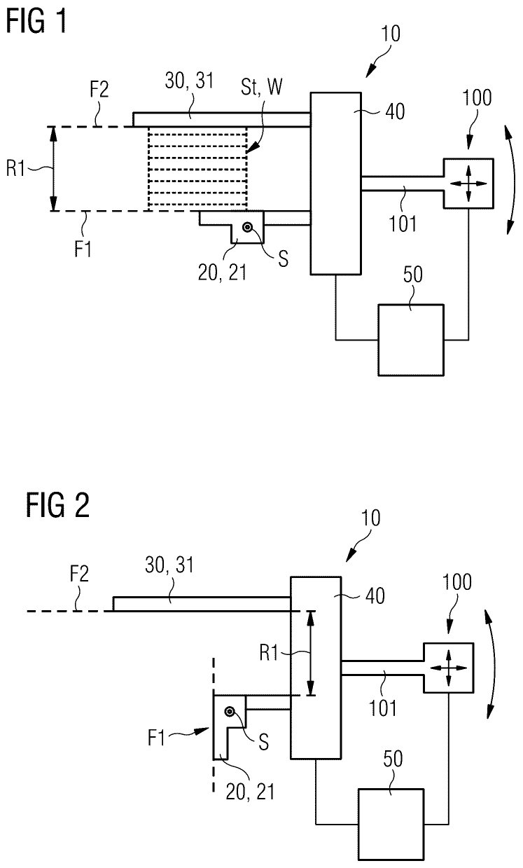

FIG. 1 shows a schematic lateral view of a gripper in accordance with one embodiment of the invention in a gripping position;

FIG. 2 shows the gripper of FIG. 1 in a release position;

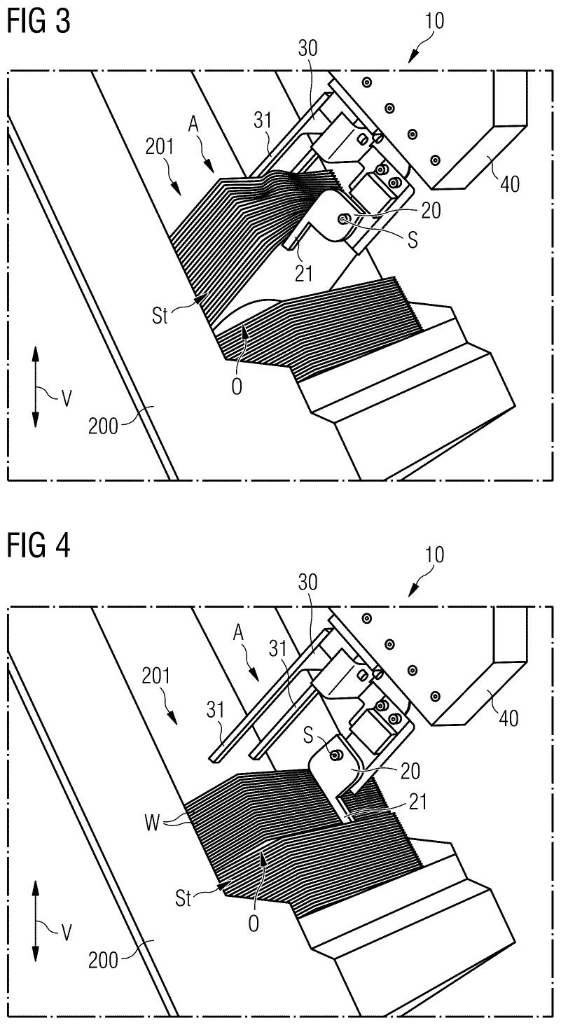

FIG. 3 shows a perspective representation of the gripper that is positioned for depositing a stack of value documents in a depositing position in the gripping position;

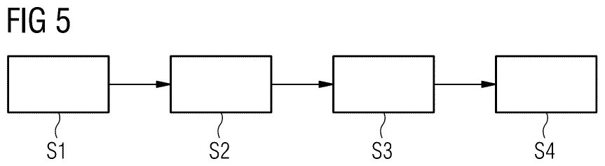

FIG. 4 shows a perspective representation of the gripper after the stack has been deposited in the release position; and

FIG. 5 shows a block diagram which illustrates schematically the sequence of a method for depositing a stack of value documents.

The embodiments described below do not mutually exclude one another but rather supplement one another. In this respect, a specific feature, a specific structure or a specific property, which is described in conjunction with one embodiment, can also be implemented in conjunction with other embodiments without deviating from the subject matter of the invention. Moreover, the position or arrangement of individual elements or steps within the described embodiments can naturally be modified without deviating from the subject matter of the invention. The description below of the appended figures is therefore not to be understood as limiting, since the scope of the invention is defined by the attached claims and also includes variants and equivalents which are not explicitly described below.

FIG. 1 illustrates a preferred embodiment of a gripper 10 in accordance with the present disclosure in a schematic lateral view. The gripper 10 is laid out to deposit a stack St of sheet material W which is illustrated schematically in FIG. 1 by the dashed line. In order to grip and hold the stack St, the gripper 10 comprises a first gripping element 20 and a second gripping element 30 which are guided adjustably with respect to one another in order to clamp or locate the stack St in a non-positive locking manner in an intermediate area between the first and the second gripping element 20, 30.

The first gripping element 20 and the second gripping element 30 form first and second contact surfaces F1, F2 for contact with the sheets which define the end of the stack St. The first gripping element 20 is mounted so as to be able to pivot about a pivot axis S so that the first gripping element can be arranged in at least two different angle orientations with respect to the second gripping element 30.

FIG. 1 shows the gripper 10 with a gripping element 20 arranged in a gripping position. In the gripping position, the first contact surface F1 and the second contact surface F2 are oriented substantially planar parallel to one another. In addition, the gripping elements 20, 30 are guided linearly adjustable with respect to one another so that they can be moved towards one another and away from one another at least in the gripping position in one direction R1, as indicated by the double arrow in FIG. 1, along the surface normals that are associated with the contact surfaces F1, F2. This renders it possible in particular to grip the stack St in a non-destructive manner with the aid of first and second contact surfaces F1, F2 that are oriented substantially planar parallel to one another in the gripping position.

The gripping elements 20, 30 are adjustably guided in a carrier 40 so that they can be moved linearly towards one another and away from one another in particular in order to open and close the gripper. The first gripping element 20 is additionally mounted so as to be able to rotate about the pivot axis S, whereas the second gripping element 30 is attached in a non-rotatable manner with respect to the carrier 40.

The first gripping element 20 is able to rotate about the pivot axis S in such a manner that the first contact surface F1 can be moved downwards from the second contact surface F2 so as to open the gripper 10 by pivoting about the pivot axis S away from the second gripping element 30. The first gripping element 20 is shown, by way of example in FIG. 2 or FIG. 4, in a release position arranged tilted by approx. 90° with respect to the gripping position of FIG. 1 or 3. In order to deposit the stack St at a depositing location O in a precise position, the first gripping element 20 is tilted from the gripping position into the release position, following which the stack St can slide along the first contact surface F1 on to the desired depositing location O under the influence of the gravitational force.

The release position is illustrated in particular in the schematic lateral representation of FIG. 2 and in the perspective representation of FIG. 4. In the release position, the first contact surface F1 runs substantially perpendicular to the second contact surface F2 and, as is particularly apparent from FIG. 4, directly after the stack St has been deposited in the intended manner parallel to the stacking direction of the deposited stack.

In the illustrated exemplary embodiment, the first gripping element 20 is formed by a pivotable gripping finger 21 which accordingly forms the first contact surface F1 for contact with the stack St. The second gripping element 30 comprises two or more elongated second gripping fingers 31 which are oriented parallel to one another and define the second contact surface F2 with respect to mutual contact with the stack St. In the gripping position, the first gripping finger 21 and the second gripping finger 31 run parallel to one another so that in the gripping position they define two contact surfaces F1, F2 which are oriented planar parallel to one another.

In other, not explicitly represented embodiments, it is provided by way of example to form or provide the first contact surface F1 by a plurality of first gripping fingers 21 which are mounted accordingly so as to be able to pivot about the pivot axis S.

In the illustrated exemplary embodiment, the first gripping finger 21 of the first gripping element 20 has a shorter longitudinal extent than the second gripping finger 31, wherein longitudinal extent refers to the length of the gripping fingers 21, 31 from their proximal free end to their carrier-side attachment, wherein the carrier-side attachment in the case of the first gripping element is predetermined by the pivot joint about the pivot axis S. The pivotably mounted, first gripping element is designed shorter in order to reduce the amount of area required for the pivot movement and thus to render it possible for the stack to be deposited in a precise position, by way of example, on an already existing stack, such as is illustrated by way of example in FIG. 3 or 4, from a relatively small height.

In order to control the movement of the first and the second gripping element 20, 30 with respect to one another, a control facility 50 is provided which actuates the control elements, not further illustrated, such as in particular electric motors or the like, in order to adjust the orientation of the first contact surface F1 about the pivot axis S and to adjust the distance between the first and second contact surfaces. The control facility is designed in particular so as to move the first contact surface F1 and the second contact surface F2 towards one another in the gripping position, wherein the movement is performed in particular when gripping the stack St preferably in the direction R1 of the surface normals that are associated with the contact surfaces.

Moreover, FIG. 1 shows schematically a transport facility 100 for moving the gripper 10 in the space. The transport facility 100 is designed so as to move the gripper 10 to different positions in the space and to orient it in different orientations in the space and comprises for this purpose at least one adjustable degree of freedom of movement which can be controlled by means of the control facility 50.

In some configurations, the transport facility 100 comprises multiple adjustable control elements that can be actuated appropriately, such as the above already mentioned electric motors, provided axes, in order to position the gripper 10 in a suitable manner in the space. The transport facility 100 is designed, by way of example, as a controllable multi-arm robot, which comprises at least one pivotable and/or moveable robotic arm 101 that comprises the gripper 10 attached to its end.

It is possible with the aid of the transport facility 100 to arrange the gripper 10 in almost any random position and orientation in the space or with respect to the gravitational field. The transport facility 100 is designed, by way of example, so as to receive the stack St at a receiving position and to transport it to a depositing position A in which the stack St is deposited at the desired depositing location O, by way of example on an existing stack.

FIGS. 3 and 4 illustrate a special exemplary embodiment in which the gripper 10 deposits a value document stack in a value document cassette 200.

FIG. 3 illustrates in a perspective representation the gripper 10 that has been moved into a depositing position A. The gripper 10 is introduced in the depositing position A into the value document cassette 200, which comprises for the value documents a shaft-shaped receptacle with a rear wall against which the value document rear edges are deposited. In order to be able to deposit the value documents as close as possible to the rear wall, the gripper 10 grips the stack St only over the stack front side which lies opposite the rear side of the stack. The value document cassette 200 or its shaft-shaped receptacle is arranged slightly inclined with respect to the gravitational field so that it runs at an angle of approx. 5° to 30° with respect to the vertical direction. In other embodiments, the value document cassette 200 is configured so that its shaft-shaped receptacle 201 runs in the direction of the vertical direction V.

In the intended manner, the value documents W are stacked in the shaft-shaped receptacle 201 of the value document cassette 200 so that their stacking direction coincides with the orientation of the shaft-shaped receptacle 201. The value document cassette 200 comprises in some configurations a sprung base on which value documents W are deposited or are to be deposited. The value document stack stored in the value document cassette 200 can thus be sprung mounted in the stacking direction.

As shown in particular in FIG. 3, the stack St that is to be deposited in the depositing position A is held by the gripper 10 in the gripping position. The stack St is held in particular with its center of gravity in the vertical direction above the depositing location O. In the depositing position A, the gripper 10 is oriented so that the first contact surface F1 is in the vertical direction V below the second contact surface F2 and the stack St that is to be deposited is thus supported by the first gripping element 20.

The stack St is deposited by pivoting the first gripping element 20 or the first contact surface F1 about the pivot axis S from the gripping position of FIG. 3 downwards into the release position of FIG. 4. When opening the gripper 10 by pivoting the first gripping element 20, the stack St slides under the influence of the gravitational force on the first gripping element 20 and in this manner arrives at the depositing location O in a precise position, the depositing location being provided in the illustrated example by the value documents that are already stacked in the value document cassette 200. In order to avoid that value documents of the stored stack are displaced by the pivot movement of the first gripping element 20, the vertical distance of the pivot axis S from the depositing location O in the depositing position A is selected to be greater than the longitudinal extent of the first contact surface F1 of the first gripping element 20 or of the gripping finger 21.

FIG. 5 shows a method for depositing the stack St of sheet material, for example of value documents W, at the depositing location O in a schematic block diagram. The method comprises the steps:

hold S1 the stack St between the first contact surface F1 and the second contact surface F2 of the gripper 10 in a gripping position as illustrated for example in FIG. 3 for a value document stack W, wherein the first and the second contact surfaces F1, F2 are arranged parallel to one another in the gripping position;

position S2 the gripper 10 in a depositing position A, as illustrated in particular in FIG. 3, wherein the center of gravity of the stack St that is held by the gripper 10 is arranged in the vertical direction V above the depositing location O and the gripper 10 is oriented in the depositing position A in such a manner that the first contact surface F1 is arranged in the vertical direction V below the second contact surface F2; and deposit S3 the stack St that is held by the gripper, wherein when depositing the stack St the first contact surface F1 is moved from the gripping position into a release position (illustrated for example in FIG. 4). In the release position, the first contact surface F1 is oriented at an angle with respect to the second contact surface F2 so that under the influence of the gravitational force the stack St can slide on the first contact surface F1 that is inclined with respect to the gravitational field onto the depositing location O.

As is particularly apparent from FIG. 4, the first contact surface F1 is oriented in the release position perpendicular to the second contact surface F2. After the stack that is held by the gripper 10 is deposited, it is provided to influence the periphery of the deposited stack in an influencing step S4 in order to ensure in particular a flush orientation of the deposited stack. For this purpose, the gripper 10 is moved in a lateral direction perpendicular to the stacking direction of the deposited stack in order to influence the peripheral edges of the stack with the first contact surface F1 which is oriented substantially parallel to the stacking direction.

Prior to the step of positioning S2 the gripper 10 into the depositing position A, the gripper 10 is optionally moved in the space from a receiving position, in which the stack is received or gripped by the gripper 10, to the depositing position A, in particular the depositing position A illustrated in FIG. 3. This is performed by controlling the degree of freedom of movement of the already described transport facility 100 which is designed so as to move and orient the gripper 10 in the space.

The above description discloses the invention with reference to specific embodiments. However, it is possible in the scope of the attached claims to deviate from the described components, elements and process sequences without deviating from the subject matter of the present invention. The description and the drawings are accordingly to be understood as illustrative but not limiting.

1.-15. (canceled)

16. A gripper for holding and depositing a stack of sheet material, at a depositing location on a base or on an existing stack, comprising:
at least one first gripping element, which comprises or forms a first contact surface for contact with the stack,
at least one second gripping element, which comprises or forms a second contact surface for contact with the stack,
wherein the first contact surface and the second contact surface are designed for contact with the stack on both sides and the first and the second gripping elements are guided adjustably with respect to one another in such a manner that the first and second contact surfaces can be moved towards one another in order to hold the stack between the first and the second contact surfaces,
wherein the first gripping element is mounted so as to be able to pivot about a pivot axis and can pivot between a gripping position, in which the first contact surface is oriented substantially parallel to the second contact surface, and a release position, in which the first contact surface is oriented at an angle with respect to the second contact surface, in order to deposit the stack at the depositing location, on a base or on an existing stack.

17. The gripper according to claim 16, wherein the first contact surface is oriented in the release position at an angle of at least 45 degrees to the second contact surface.

18. The gripper according to claim 16, wherein the second gripping element is attached in a non-rotatable manner to the gripper.

19. The gripper according to claim 16, wherein the first contact surface is formed by at least one elongated first gripping finger of the first gripping element and the second contact surface is formed by at least one elongated second gripping finger of the second gripping element,
wherein a longitudinal extent of the at least one first gripping finger is shorter than a longitudinal extent of the at least one second gripping finger.

20. The gripper according to claim 16, wherein the first gripping element can be moved away from the second gripping element by pivoting about the pivot axis in the direction of the release position in such a manner that the distance between the first contact surface and the second contact surface is increased when pivoting from the gripping position into the release position.

21. An apparatus for depositing a stack of sheet material, at a depositing location, on a base or on an existing stack, having:
a gripper according to claim 16 and
a control facility for controlling the movement of the first gripping element and second gripping element, with respect to their distance from one another and/or with respect to their orientation with respect to one another.

22. The apparatus according to claim 21, wherein a transport facility for moving the gripper, the transport facility being designed so as to move the gripper to different positions in the space and where appropriate to set it up in different orientations in the space,
wherein the control facility is designed so as to control the movement and orientation of the gripper in the space, independently from the movement of the first and second contact surfaces.

23. The apparatus according to claim 21, wherein the control facility is designed so as to position the gripper holding the stack into a depositing position in which the first contact surface is arranged below the second contact surface and to deposit the stack held by the gripper by means of the gripper that is located in the depositing position,
wherein, in order to deposit the stack, the first contact surface is pivoted from the gripping position into the release position in which the first contact surface is oriented at an angle with respect to the second contact surface.

24. The apparatus according to claim 21, wherein the control facility is designed so as to select the depositing position of the gripper in such a manner:
that in the depositing position the center of gravity of the stack that is held by the gripper is arranged in the vertical direction above the depositing location of the stack, and/or
that in the depositing position the vertical distance of the pivot axis from the depositing location is greater than the longitudinal extent of the first contact surface of the first gripping element.

25. The apparatus according to claim 21, wherein the control facility is designed so as to move the contact surface in a direction perpendicular to a stacking direction of the stack in order to influence the periphery of the deposited stack after the stack that is held by the gripper has been deposited.

26. A method for depositing a stack of sheet material, at a depositing location, on a base or on an existing stack, wherein the steps:
hold a stack between a first and a second contact surface of a gripper in a gripping position,
wherein the first and the second contact surfaces are arranged substantially parallel to one another in the gripping position;
position the gripper that is holding the stack into a depositing position, in which the gripper is oriented in such a manner that the first contact surface is arranged in the vertical direction below the second contact surface;
deposit the stack that is held by the gripper by means of the gripper that is located in the depositing position,
wherein, in order to deposit the stack, the first contact surface is pivoted from the gripping position into a release position in which the first contact surface is oriented at an angle with respect to the second contact surface.

27. The method according to claim 26, wherein the first contact surface is oriented in the release position at an angle of at least 45 degrees to the second contact surface.

28. The method according to claim 26, wherein, when positioning the gripper, the depositing position of the gripper is selected in such a manner:
that in the depositing position the center of gravity of the stack that is held by the gripper is arranged in the vertical direction above the depositing location of the stack and/or
that in the depositing position the vertical distance of the pivot axis from the depositing location is greater than the longitudinal extent of the first contact surface of the first gripping element.

29. The method according to claim 26, wherein, after the stack that is held by the gripper has been deposited, the first contact surface is moved in a direction perpendicular to a stacking direction of the stack in order to influence the periphery of the deposited stack.

30. The method according to claim 26, wherein, prior to the step of positioning the gripper into the depositing position, the following step is performed:
move the gripper in the space from a receiving position, in which the stack is gripped by the gripper, to the depositing position.
